(19) United States
(12) Patent Application Publication
(10) Pub. No.: US 2026/0010984 A1
(43) Pub. Date: Jan. 8, 2026

(54) FILM GRAIN SYNTHESIS WITH FALLBACK MECHANISMS

(71) Applicant: NETFLIX, INC., Los Gatos, CA (US)

(72) Inventors: Li-Heng CHEN, Campbell, CA (US); Liwei GUO, San Francisco, CA (US); Andrey NORKIN, Campbell, CA (US); Zhi LI, Mountain View, CA (US); Anush MOORTHY, Redwood City, CA (US)

(21) Appl. No.: 19/257,113

(22) Filed: Jul. 1, 2025

Related U.S. Application Data
(60) Provisional application No. 63/667,663, filed on Jul. 3, 2024.

(51) Int. Cl. G06T 5/70; G06V 20/40; H04N 19/172

(52) U.S. Cl. CPC G06T 5/70; G06V 20/49; H04N 19/172; G06T 2207/20182

(57) ABSTRACT

In various embodiments, A computer-implemented method for selectively applying film grain synthesis when encoding and decoding media titles includes determining that a film grain synthesis operation should be applied to a first portion of video data, determining that the film grain synthesis operation should not be applied to a second portion of video data, and generating encoded video data based on the first portion of video data and the second portion of video data, wherein the film grain synthesis operation is applied to the first portion of video data when decoding the encoded video data and the film grain synthesis operation is not applied to the second portion of video data when decoding the encoded video data.

### CROSS-REFERENCE TO RELATED APPLICATIONS

This application claims the benefit of U.S. Provisional Application titled “TECHNIQUES FOR FILM GRAIN SYNTHESIS WITH FALLBACK MECHANISM,” filed on Jul. 3, 2024, and having Ser. No. 63/667,663. The subject matter of this related application is hereby incorporated herein by reference.

### BACKGROUND

### Field of the Various Embodiments

Embodiments of the present disclosure relate generally to computer science and video processing and, more specifically, film grain synthesis with fallback mechanisms.

### DESCRIPTION OF THE RELATED ART

Modern streaming services stream audiovisual content related to media titles to endpoint devices via a network. To conserve network bandwidth and maintain high network throughput, audiovisual content is typically encoded into a compressed form prior to transmission across the network. Some media titles include visual characteristics that can complicate the encoding process and lead to low-efficiency compression. One such visual characteristic is known as “film grain.”

Film grain is a subtle visual distortion that resembles the visual qualities of physical film once used in traditional cinema. Film grain frequently appears in media titles that are digital representations of older physical films or in modern films that are intended to appear older. Film grain is generally a desirable and/or intentional visual characteristic and should therefore be preserved during the encoding and subsequent decoding process to the extent possible. Accordingly, various techniques have been developed for removing film grain prior to encoding and then reintroducing the film grain once the encoded video has been decoded. Through these techniques, film grain can often be preserved while circumventing some of the encoding complications mentioned above.

However, one drawback associated with conventional approaches to preserving film grain is that the process for removing film grain and later reintroducing the film grain is unreliable and occasionally fails. When the process fails for a given media title, the media title as a whole cannot be efficiently encoded to a compressed size. Consequently, transmitting media titles that include film grain often utilizes excessive network bandwidth and reduces network throughput.

As the foregoing illustrates, what is needed in the art is a more effective technique for preserving film grain when encoding video.

### SUMMARY

In various embodiments, A computer-implemented method for selectively applying film grain synthesis when encoding and decoding media titles includes determining that a film grain synthesis operation should be applied to a first portion of video data, determining that the film grain synthesis operation should not be applied to a second portion of video data, and generating encoded video data based on the first portion of video data and the second portion of video data, wherein the film grain synthesis operation is applied to the first portion of video data when decoding the encoded video data and the film grain synthesis operation is not applied to the second portion of video data when decoding the encoded video data.

At least one technical advantage of the disclosed techniques relative to the prior art is that the disclosed techniques enable the preservation of film grain characteristics when possible. In addition, the disclosed techniques allow source video that includes film grain to be encoded with greater efficiency compared to conventional approaches, thereby conserving network bandwidth. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments;

FIG. 4 is a more detailed block diagram of the endpoint device of FIG. 1, according to various embodiments;

FIG. 5 illustrates an encoding pipeline configured to encode media titles, according to various embodiments;

FIG. 6 is a more detailed illustration of the film grain processing service of FIG. 5, according to various embodiments;

FIG. 7 illustrates how the film grain processing service of FIG. 6 selectively applies film grain synthesis, according to various embodiments;

FIG. 8 illustrates how a film grain synthesis processed video is used to encode video data, according to various embodiments; and

FIG. 9 is a flow diagram of method steps for encoding video using film grain synthesis, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Film grain is a subtle visual distortion that resembles the visual qualities of the physical film once used in traditional cinema. Film grain frequently appears in media titles that are digital representations of older physical films or in modern films that are intended to appear older. As film grain is generally a desirable and/or intentional visual characteristic, the film grain should be preserved during the encoding and subsequent decoding process to the greatest extent possible. Accordingly, various techniques have been developed for removing film grain prior to encoding and then reintroducing the film grain once the encoded video has been decoded. However, one drawback associated with conventional approaches to preserving film grain is that the process for removing film grain and later reintroducing the film grain is unreliable and occasionally fails. When the process fails for a given media title, the media title cannot be efficiently encoded to a compressed size. Consequently, transmitting media titles that include film grain frequently utilizes excessive network bandwidth and reduces network throughput.

To address the aforementioned issues, a video encoding pipeline includes a film grain processing service (FGPS) configured to process a source video to generate a film-grain synthesis (FGS) processed video. The FGS processed video specifies different portions of a source video that should be encoded and decoded using film grain synthesis techniques, as well as other portions of the source video that do not require such encoding and decoding techniques. The FGPS divides the source video into different segments having a given duration. The FGPS then attempts to denoise each segment to remove film grain characteristics and also attempts to model the film grain characteristics of each segment. The FGPS evaluates whether the denoising and/or modeling operations are successful and then generates a set of film grain decisions. The set of film grain decisions indicates the specific portions of the source video that successfully underwent the denoising and film grain modeling operations, along with other portions of the source video for which either operation failed.

Based on the film grain decisions, the FGPS generates a set of film grain tables for each portion of the source video where both the denoising and film grain modeling operations were successful. For a given portion of the source video, the corresponding film grain table includes film grain model parameters that can be used to reproduce the film grain included in that portion. The FGPS then generates, based on the film grain decisions, the FGS processed video. The FGS processed video includes a sequence of pointers that indicate, for each portion of the source video, either a corresponding portion of the source video or a corresponding portion of denoised video. Subsequently, during encoding, an encoder uses the FGS processed video to generate an encoded video that includes some segments taken directly from the source video and other segments generated by the denoising operation. The encoded video also includes the set of film grain tables. During streaming, an endpoint device can decode the encoded video and then use the film grain tables to reproduce the film grain characteristics removed via the denoising operation, and then reintroduce the film grain characteristics into the denoised segments.

At least one technical advantage of the disclosed techniques relative to the prior art is that the disclosed techniques enable the preservation of film grain characteristics when possible. In addition, the disclosed techniques allow source video that includes film grain to be encoded with greater efficiency compared to conventional approaches, thereby conserving network bandwidth. These technical advantages provide one or more technological advancements over prior art approaches.

### System Overview

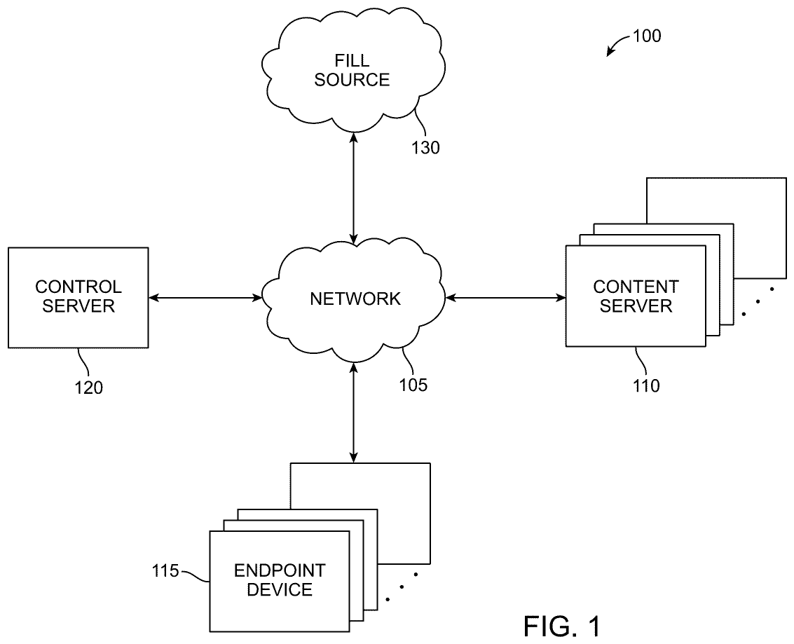

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

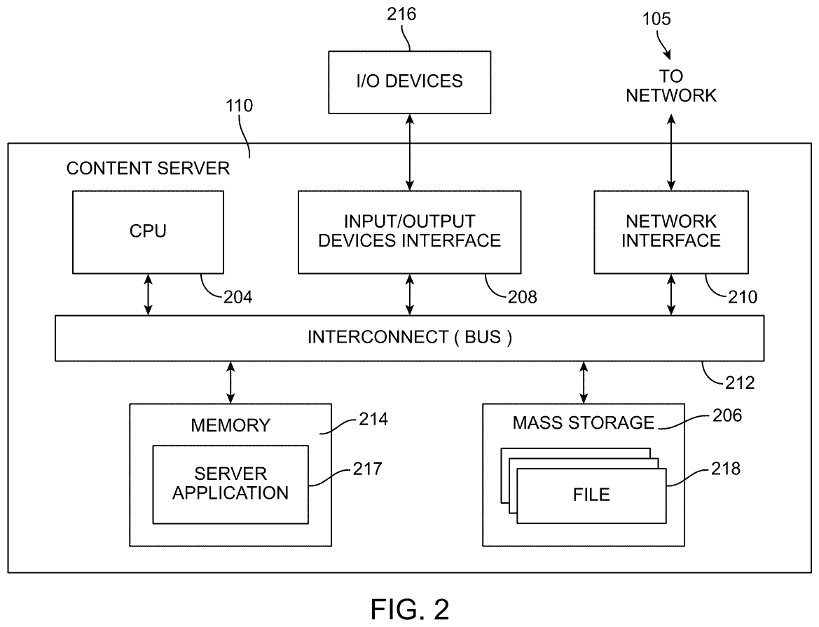

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

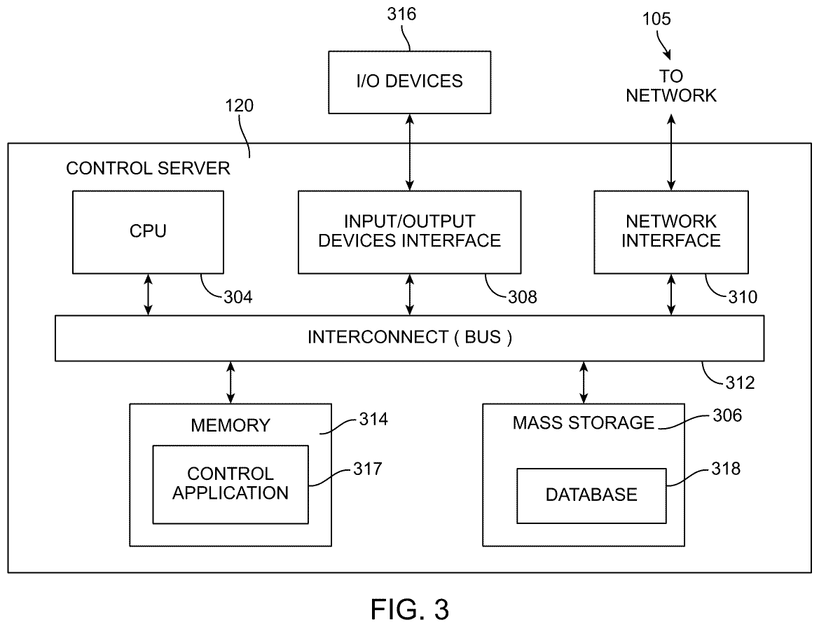

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage.

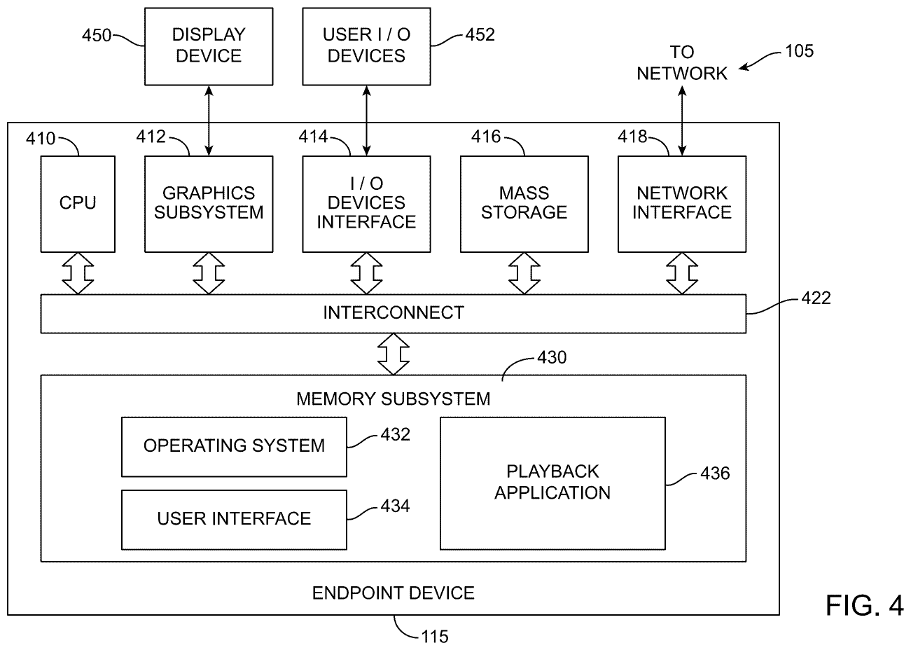

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via display device.

### Film Grain Synthesis with Fallback Mechanism

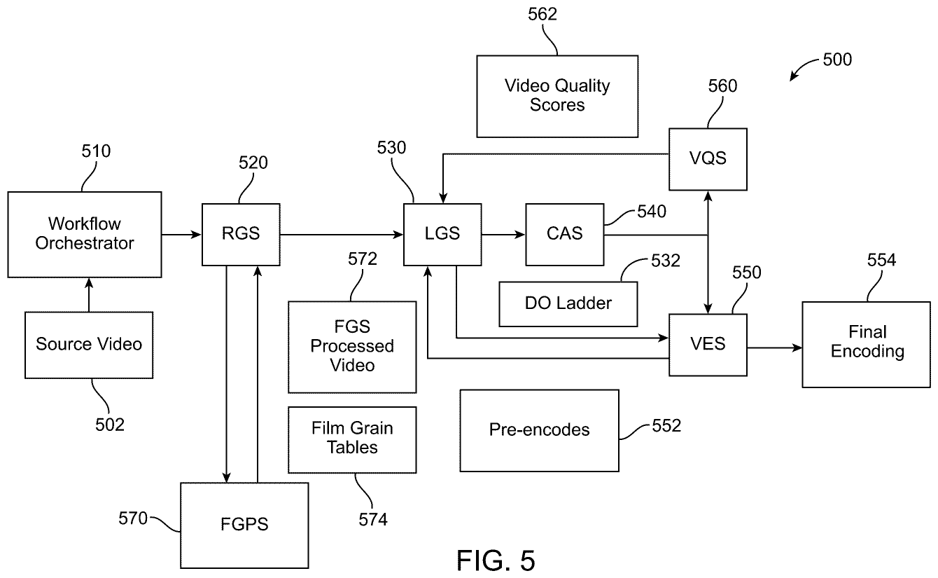

FIG. 5 illustrates an encoding pipeline configured to encode media titles, according to various embodiments. As shown, the encoding pipeline 500 includes a workflow orchestrator 510, a recipe generation service (RGS) 520, a ladder generation service (LGS) 530, a complexity analysis service (CAS) 540, a video encoder service (VES) 550, a video quality service (VQS) 560, and a film-grain processing service (FGPS) 570. In operation, the encoding pipeline 500 is configured to encode a source video 502 and generate a final encoding 554. In addition, with film grain processing enabled via FGPS 570, the encoding pipeline 500 can efficiently encode source videos that include film grain characteristics and preserve such characteristics during a subsequent decoding process.

As a general matter, and as known in the art, film grain processing techniques involve modeling the film grain characteristics of a given source video, removing film grain prior to encoding the source video, subsequently decoding the source video, synthesizing film grain based on the modeled film grain characteristics, and then reintroducing the synthesized film grain into the decoded source video. Such techniques can be implemented via the Alliance for Open Media Video 1 (AV1) codec. As referred to herein, the term “film grain synthesis” generally refers to operations involved with synthesizing film grain that has been removed from a given portion of video data and then adding the synthesized film grain to a decoded version of that portion of video data.

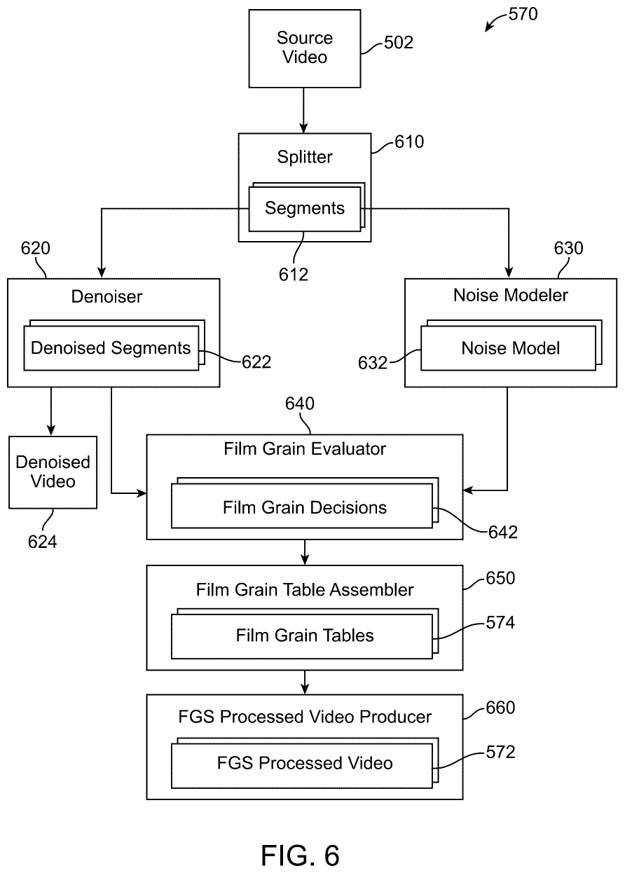

The workflow orchestrator 510 coordinates the operation of the RGS 520, the LGS 530, the CAS 540, the VES 550, the VQS 560, and the FGPS 570 when encoding the source video 502. The RGS 520 initially implements the FGPS 570 to convert the source video 502 into a film-grain synthesis (FGS) processed video 572. As described in greater detail below in conjunction with FIG. 6, the FGS processed video 572 includes an array of pointers that indicate specific portions of the source video 502 that can be encoded and decoded using film grain synthesis techniques and other portions of the source video 502 that should not be encoded and decoded using such techniques. The FGPS 570 also generates film grain tables 574 that indicate, for the specific portions of the source video where film grain synthesis techniques can be applied, noise parameters that can be used to reconstruct the film grain characteristics of those portions of the source video. Based on the FGS processed video 572, the RGS 520 formulates encoding settings, including bitrate, resolution, quantization, pixel format, and bit depth, for example and without limitation. A collection of such settings is referred to herein as an “encoding recipe.”

The LGS 530 then generates a set of encoding recipes, where each recipe represents a specific combination of encoding settings, including different bitrates and resolutions. A set of encoding recipes is referred to herein as a “bitrate ladder.” The LGS 530 can output a simple bitrate ladder that includes constant bitrate and resolution, i.e., a fixed-bitrate ladder. Alternatively, the LGS 530 can generate a dynamically-optimized (DO) ladder 532 that can be used to adjust encoding settings based on the complexity of different portions of the FGS processed video 572. The LGS 530 generates the DO ladder 532 using the CAS 540. The CAS 540 implements various encoder settings, including resolution, quantization parameter, and so forth, to generate pre-encodes 552 using the VES 550.

The VES 550 can implement any technically feasible technique for encoding frames of video data, including, for example and without limitation, interframe and/or intraframe encoding techniques. The CAS 540 also causes the VQS 560 to generate video quality scores 562 for the pre-encodes 552. The VQS 560 can implement any technically feasible approach to analyzing frames of video and generating quality metrics, including, for example and without limitation, a video multimethod assessment fusion (VMAF) technique. Based on the pre-encodes 552 and the video quality scores 562, the LGS 530 selects optimal parameters for encoding different portions of the FGS processed video 572, thereby generating the DO ladder 532. In some embodiments, the aforementioned techniques for generating the DO ladder 532 can be performed based on the source video 502 without first converting the source video to the FGS processed video 572.

Using the different combinations of parameters set forth in the DO ladder 532, the VES 550 generates the final encoding 554. For portions of the source video 502 for which film grain synthesis can be applied during encoding, the final encoding 554 also includes corresponding film grain parameters derived from the film grain tables 574. The final encoding 554 can then be distributed to endpoint devices 115. During streaming, a given endpoint device 115 streams one or more channels of video associated with the final encoding 554 and implements a decoder to decode different portions of video. For portions of video where film grain synthesis was applied during encoding, the decoder generates film grain characteristics using the corresponding film grain parameters and reintroduces such characteristics into the video. For the other portions of video, where film grain synthesis techniques could not be applied, the decoder defaults to conventional decoding. Under such an approach, film grain synthesis can be applied to specific portions of the source video where such techniques are feasible and not applied where such techniques are not feasible.

FIG. 6 is a more detailed illustration of the film grain processing service (FGPS) of FIG. 5, according to various embodiments. As shown, the FGPS 570 includes a splitter 610, a denoiser 620, a noise modeler 630, a film grain evaluator 640, a film grain table assembler 650, and an FGS processed video producer 660. In operation, the splitter 610 receives the source video 502 and divides the source video 502 into segments 612, where each segment includes one or more frames of video data. In some embodiments, segments 612 have a fixed duration, e.g., two seconds. In addition, in various embodiments, the source video is organized into shots, where each shot includes a sequence of video frames captured continuously from a given viewpoint, and each shot is divided by the splitter 610 into at least one segment.

The denoiser 620 performs a denoising operation to generate denoised segments 622. The denoiser can implement any technically feasible technique for removing noise, film grain, and other high-frequency visual artifacts from the segments 612, including, for example, a Gaussian blur, a bilateral filter, or a non-local means technique, without limitation. The denoised segments 622 can be recombined to generate a denoised video 624. In some instances, the denoising operation may fail for a given segment 612, and so the denoised video 624 may not include a corresponding denoised segment 622 corresponding to the given segment 612. Various types of failure modes are described in greater detail below. The denoised video 624 is cached for later use.

In conjunction with the operation of the denoiser 620, the noise modeler 630 performs a noise estimation operation with the segments 612 to generate a noise model 632. The noise modeler 630 can implement any technically feasible technique for modeling noise in general, and film grain in particular, including, for example, a Yule Walker algorithm, without limitation. The noise model 632 generally includes noise parameters that can be used to reproduce, at least in part, the film grain characteristics removed by the denoiser 620. In some instances, the noise estimation operation may fail for a given segment 612, and so the noise model 632 may not include a noise model for all segments 612. Various types of failure modes are described in greater detail below. The noise model 632 is cached for later use.

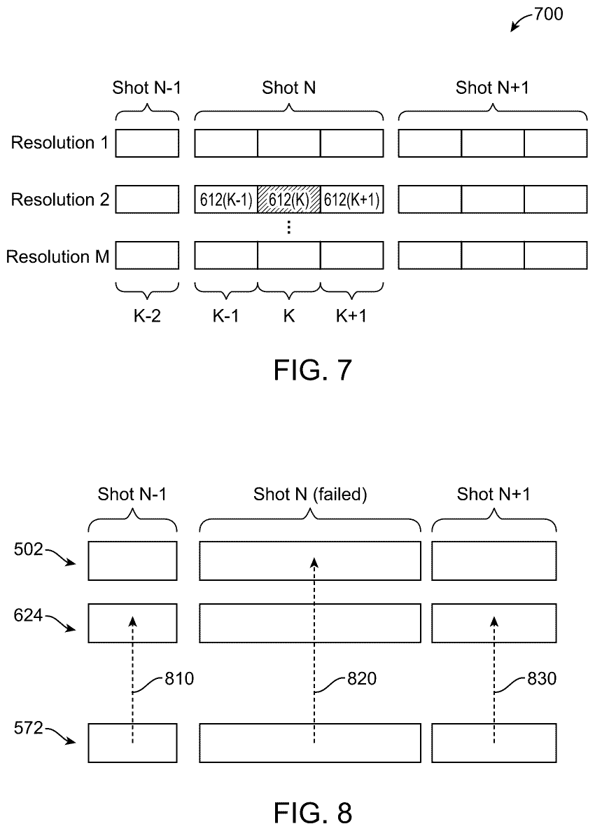

The film grain evaluator 640 analyzes the denoised video 624 and the noise model 632 and then generates film grain decisions 642. In so doing, the film grain evaluator 640 evaluates whether the denoising operation and/or the noise estimation operation were successful for a given segment. If both operations were performed successfully for a given segment 612, then the film grain decisions 642 indicate that film grain synthesis techniques can be applied to that segment. If either operation was not successful for a given segment 612, however, then the film grain decisions 642 indicate that film grain synthesis should not be applied to that segment and also should not be applied to any other segment within the same shot across all resolutions. Accordingly, film grain synthesis is either enabled for a given shot across all resolutions or disabled for that shot across all resolutions. This particular operation is discussed in greater detail below in conjunction with FIG. 7. In some embodiments, the film grain evaluator 640 can determine that film grain synthesis should be disabled for a given shot when the source video 502 does not include film grain characteristics in that shot or the strength and/or standard deviation of the film grain falls below a threshold.

The film grain evaluator 640 may determine that the denoising operation and/or the noise estimation operation were unsuccessful for a given segment 612 for several possible reasons. For example, and without limitation, the film grain evaluator 640 could determine that the denoiser 620 and/or the noise modeler 630 experienced a non-transient execution error during operation and/or failed to converge within a given time limit, thereby failing to generate output for the segment 612. The film grain evaluator 640 could also determine that the output of the denoising operation and/or the noise estimation operation is undesirable.

In particular, the film grain evaluator 640 could determine that a given denoised segment 622 does not meet one or more quality criteria. For example, and without limitation, the film grain evaluator 640 could determine that the denoised segment 622 has pixel values that are significantly different from the corresponding original segment 612. The film grain evaluator 640 could also determine that a video quality score generated for the denoised segment 612 falls below a threshold compared to the corresponding original segment 612. The video quality score could be peak signal-to-noise ratio (PSNR) or VMAF, among others. The film grain evaluator 640 could also determine that a confidence score assigned to the denoised segment 622 falls below a threshold value.

In like fashion, the film grain evaluator 640 could determine that a given noise model 632 does not meet one or more quality criteria. For example, and without limitation, the film grain evaluator 640 could determine that the variance of grain synthesized using the noise model 632 is larger than a threshold value. The film grain evaluator 640 could also determine that the standard deviation of synthesized grain at lower resolutions is greater than the standard deviation of the synthesized grain at the source resolution. The film grain evaluator 640 could also determine that a confidence score assigned to the noise model 632 falls below a threshold value.

The film grain table assembler 650 processes the film grain decisions 642 to generate the film grain tables 574, also shown in FIG. 5. For each segment 612 where film grain synthesis can be applied, the film grain tables 574 include a set of noise parameters derived from the noise model 632, such as grain strength, grain seen, grain distribution model, and scaling factors, for example and without limitation. The film grain tables 574 generally include one or more film grain tables for each shot where film grain synthesis is enabled and do not include any film grain tables for any shots where film grain synthesis is disabled.

The FGS processed video producer 660 processes the denoised video 624 in conjunction with the film grain tables 574 to generate the FGS processed video 572. The FGS processed video 572 includes an array of pointers that indicate, for each shot, a corresponding shot in either the source video 502 or the denoised video 624. In particular, for any shot where film grain synthesis is disabled, then for that shot the FGS processed video 572 includes a pointer to the corresponding shot in the source video 502. Similarly, for any shot where film grain synthesis is enabled, then for that shot the FGS processed video 572 includes a pointer to the corresponding shot in the denoised video 624.

Referring now to FIG. 5, during encoding, the VES 550 generates the final encoding 554 on a shot-by-shot basis using the pointers included in the FGS processed video 572. For example, and without limitation, when encoding a shot with film grain synthesis disabled, the VES 550 would use a pointer included in the FGS processed video 572 to access frames of video from the source video 502. On the other hand, when encoding a shot with film grain synthesis enabled, the VES 550 would use a pointer included in the FGS processed video 572 to access frames of video from the denoised video 624. In the latter case, the VES 550 would also access the film grain table(s) 574 corresponding to that shot and include those tables in one or more frame headers during the encoding operation. Doing so allows an encoder to subsequently reconstruct the relevant film grain characteristics and reintroduce the film grain characteristics into decoded video derived from the final encoding 554.

FIG. 7 illustrates how the film grain processing service of FIG. 6 selectively applies film grain synthesis, according to various embodiments. As shown, a portion 700 of the source video 502 includes shots N−1, N, and N+1 at resolutions 1 and 2 through M. Shot N−1 includes segment K−2. Shot N includes segments K−1, K, and K+1. As mentioned above, the splitter 610 is configured to divide shots into one or more segments 612. In the example discussed herein, shot N at resolution 2 includes segments 612(K−1), 612(K), and 612(K+1).

As also mentioned above, if either the denoising operation or the noise estimation operation is not successful for a given segment 612, then film grain synthesis should not be applied to that segment and also should not be applied to any other segment within the same shot, across all resolutions. Accordingly, if either of the denoising or noise estimation operations fails for segment 612(K), then film grain synthesis is not applied to any of segments 612 (K−1), 612(K), and 612 (K+1) across any of resolutions 1 through M. The film grain evaluator 640 is configured to indicate such results in the film grain decisions 642. The purpose of the disclosed technique is to maintain consistent visual quality across an entire shot at any given resolution. Accordingly, when video resolution changes during streaming of a given shot, e.g., during adaptive streaming, among other reasons, the film grain characteristics of the displayed video are relatively similar for the duration of the shot.

In various embodiments, the disclosed techniques can be applied to disable film grain synthesis across all segments included in a given shot for just one resolution, to disable film grain synthesis for just one segment included in a given shot across all resolutions, or, as discussed above, to disable film grain synthesis for an entire shot across all resolutions when either denoising or noise estimation fails for any one segment included in that shot at any resolution.

FIG. 8 illustrates how a film grain synthesis processed video is used to encode video data, according to various embodiments. As shown, the source video 502, the denoised video 624, and the FGS processed video 572 are divided into shots N−1, N, and N+1. For any given shot, the FGS processed video 572 includes a pointer that indicates a corresponding shot in either the source video 502 or the denoised video 624. In particular, as shown, the FGS processed video 572 includes a pointer 810 associated with shot N−1 indicating corresponding shot N−1 in the denoised video 624. The FGS processed video 572 also includes a pointer 820 associated with shot N indicating corresponding shot N in the source video 502. The FGS processed video 572 further includes a pointer 830 associated with shot N+1 indicating corresponding shot N+1 in the denoised video 624. In the example shown, the pointers 810 and 830 indicate shots included in the denoised video 624 because both the denoising operation and noise estimation operations were successful for all segments included in those shots across all resolutions. However, the pointer 820 indicates shot N included in the source video 502 because the denoising operation and/or the noise estimation operation failed for at least one segment 612 included in the source video 502 and at least one resolution for shot N. During encoding, the VES 550 uses the pointers included in the FGS processed video 572 to access video data from the relevant location, either the source video 502 or the denoised video 624.

The disclosed approach conserves storage space by avoiding copying different portions of the source video 502 and/or the denoised video 624 and instead using pointers to indicate such portions. In addition, the disclosed technique allows different FGS processed videos to be generated in response to different success and failure outcomes across different shots. For example, and without limitation, if a previously unsuccessful denoising operation for a segment in a given shot subsequently completes successfully and generates an acceptable denoised segment, then the FGS processed video 574 can be modified to reference that denoised segment without needing to reprocess other segments.

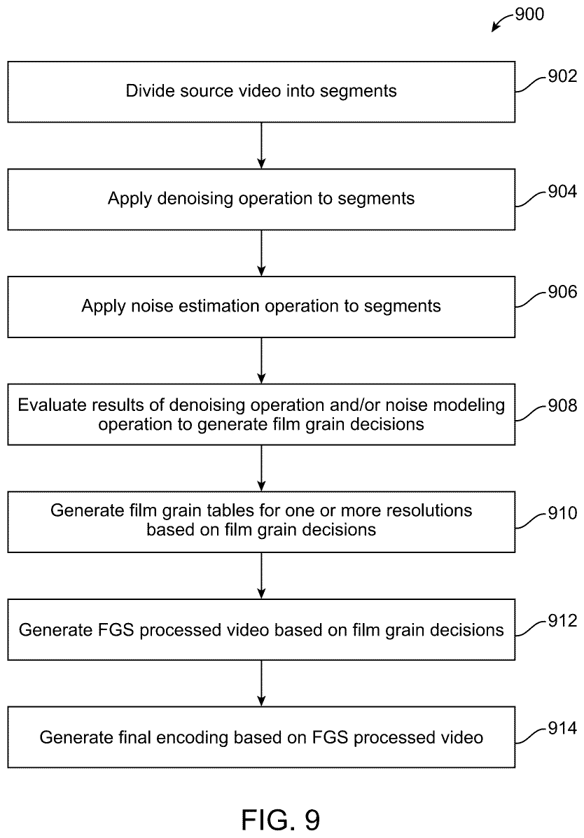

FIG. 9 is a flow diagram of method steps for encoding video using film grain synthesis, according to various embodiments. Although the method steps are described in conjunction with the systems of FIGS. 1-7, persons skilled in the art will understand that any system configured to perform the method steps, in any order, is within the scope of the present invention.

As shown, a method 900 begins at step 902, where the splitter 610 shown in FIG. 6 divides the source video 502 into segments 612. The source video 502 includes frames of video data at one or more resolutions and is generally organized into shots. A given shot includes a sequence of frames of video data captured continuously from one viewpoint, such as a camera or camera angle. The splitter 610 is configured to divide each shot into at least one segment 612. A given segment 612 generally has a particular duration, e.g., two seconds. Segment boundaries are also generally aligned with shot boundaries.

At step 904, the denoiser 620 applies a denoising operation to the segments 612 to generate denoised segments 622. The denoising operations performed at step 620 may remove visual artifacts and other forms of noise, including film grain characteristics, among others. For some segments 612, the denoising operation may fail or produce undesirable results. For example, and without limitation, the denoising operation may experience a non-transient error, or generate a denoised segment 622 that is significantly different from the original segment 612.

At step 906, the noise modeler 630 applies a denoising operation to the segments 612 to generate the noise model 632. The noise modeler 630 can implement any technically feasible technique for modeling film grain, including, for example, a Yule Walker algorithm, without limitation. The noise model 632 generally includes noise parameters that can be used to reconstruct film grain characteristics removed at step 904. In some instances, the noise estimation operation may fail for a given segment 612 or produce undesirable results. For example, and without limitation, the noise estimation operation could fail to converge during execution or result in synthesized film grain that does not meet various quality criteria.

At step 908, the film grain evaluator 640 evaluates the results of the denoising operation performed at step 904 and the noise estimation operation performed at step 906 to generate film grain decisions 642. The film grain evaluator 640 can evaluate the denoising operation and/or the noise estimation operation to determine whether those operations were successful or unsuccessful for a given segment 612 under various conditions. For example, and without limitation, the film grain evaluator 640 could determine that the denoiser 620 and/or the noise modeler 630 experienced a non-transient execution error during operation and/or failed to converge within a given time limit and then deem either or both of those operations unsuccessful. The film grain evaluator 640 could also determine that the output of the denoising operation and/or the noise estimation operation is undesirable, and then deem either or both of those operations unsuccessful. If any of the denoising or noise estimation operations are not successful for a given segment, then the film grain evaluator 640 indicates in the film grain decisions 642 that film grain synthesis cannot be applied to that segment or any other segment associated with the same shot, across all resolutions.

At step 610, the film grain table assembler 650 generates film grain tables 574 for one or more resolutions based on the film grain decisions 642. For each segment 612 where film grain synthesis techniques can be applied, the film grain tables 574 include a set of noise parameters derived from the noise model 632, such as grain strength, grain seen, grain distribution model, and scaling factors, for example and without limitation. The film grain tables 574 generally include one or more film grain tables for each shot where film grain synthesis is enabled and do not include any film grain tables for any shots where film grain synthesis is disabled.

At step 912, the FGS processed video producer 660 generates the FGS processed video 572 based on the film grain decisions 642. The FGS processed video 572 includes an array of pointers that indicate, for each shot, a corresponding shot in either the source video 502 or the denoised video 624. In particular, for any shot where film grain synthesis is disabled, then for that shot the FGS processed video 572 includes a pointer to the corresponding shot in the source video 502. Similarly, for any shot where film grain synthesis is enabled, then for that shot the FGS processed video 572 includes a pointer to the corresponding shot in the denoised video 624.

At step 914, the VES 550 generates the final encoding 554 based on the FGS processed video 572. In particular, the VES 550 generates the final encoding 554 on a shot-by-shot basis using the pointers included in the FGS processed video 572. For example, and without limitation, when encoding a shot with film grain synthesis disabled, the VES 550 would use a pointer included in the FGS processed video 572 that indicates frames of video in the source video 502. On the other hand, when encoding a shot with film grain synthesis enabled, the VES 550 would use a pointer included in the FGS processed video 572 that indicates frames of video in the denoised video 624. In the latter case, the VES 550 would also access the film grain table(s) 574 corresponding to that shot and include those tables in one or more frame headers during the encoding operation. Subsequently, during streaming, an encoder included in an endpoint device 115 can reconstruct the relevant film grain and reintroduce that film grain into decoded video derived from the final encoding 554, for the specific shots where film grain synthesis is enabled. For other shots, frames of video that already include film grain characteristics are decoded.

In sum, a video encoding pipeline includes a film grain processing service (FGPS) configured to process a source video to generate a film-grain synthesis (FGS) processed video. The FGS processed video specifies different portions of a source video that should be encoded and decoded using film grain synthesis techniques, as well as other portions of the source video that do not require such encoding and decoding techniques. The FGPS divides the source video into different segments having a given duration. The FGPS then attempts to denoise each segment to remove film grain characteristics and also attempts to model the film grain characteristics of each segment. The FGPS evaluates whether the denoising and/or modeling operations are successful and then generates a set of film grain decisions. The set of film grain decisions indicates the specific portions of the source video that successfully underwent the denoising and film grain modeling operations, along with other portions of the source video for which either operation failed.

Based on the film grain decisions, the FGPS generates a set of film grain tables for each portion of the source video where both the denoising and film grain modeling operations were successful. For a given portion of the source video, the corresponding film grain table includes film grain model parameters that can be used to reproduce the film grain included in that portion. The FGPS then generates, based on the film grain decisions, the FGS processed video. The FGS processed video includes a sequence of pointers that indicate, for each portion of the source video, either a corresponding portion of the source video or a corresponding portion of denoised video. Subsequently, during encoding, an encoder uses the FGS processed video to generate an encoded video that includes some segments taken directly from the source video and other segments generated by the denoising operation. The encoded video also includes the set of film grain tables. During streaming, an endpoint device can decode the encoded video and then use the film grain tables to reproduce the film grain characteristics removed via the denoising operation, and then reintroduce the film grain characteristics into the denoised segments.

At least one technical advantage of the disclosed techniques relative to the prior art is that the disclosed techniques enable the preservation of film grain characteristics when possible. In addition, the disclosed techniques allow source video that includes film grain to be encoded with greater efficiency compared to conventional approaches, thereby conserving network bandwidth. These technical advantages provide one or more technological advancements over prior art approaches.
1. Various embodiments include a computer-implemented method for selectively applying film grain synthesis when encoding and decoding media titles, the method comprising determining that a film grain synthesis operation should be applied to a first portion of video data, determining that the film grain synthesis operation should not be applied to a second portion of video data, and generating encoded video data based on the first portion of video data and the second portion of video data, wherein the film grain synthesis operation is applied to the first portion of video data when decoding the encoded video data and the film grain synthesis operation is not applied to the second portion of video data when decoding the encoded video data.
2. The computer-implemented method of clause 1, wherein determining that the film grain synthesis operation should be applied to the first portion of video data comprises performing a denoising operation with the first portion of video data to generate a portion of denoised video data, performing a noise estimation operation with the first portion of video data to generate a noise model, and determining that the portion of denoised video data meets a first criterion, and determining that the noise model meets a second criterion.
3. The computer-implemented method of any of clauses 1-2, wherein determining that the film grain synthesis operation should not be applied to the second portion of video data comprises determining that a denoising operation or a noise estimation operation could not be performed with the second portion of video data.
4. The computer-implemented method of any of clauses 1-3, wherein determining that the film grain synthesis operation should not be applied to the second portion of video data comprises performing a denoising operation with the second portion of video data to generate a portion of denoised video data, performing a noise estimation operation with the second portion of video data to generate a noise model, and determining that the portion of denoised video data does not meet a first criterion, or determining that the noise model does not meet a second criterion.
5. The computer-implemented method of any of clauses 1-4, wherein the first portion of video data corresponds to a first shot included in source video data, and the second portion of video data corresponds to a second shot included in the source video data.
6. The computer-implemented method of any of clauses 1-5, wherein the first portion of video data corresponds to a first set of resolutions associated with a first shot included in source video data, and the second portion of video data corresponds to a second set of resolutions associated with a second shot included in the source video data.
7. The computer-implemented method of any of clauses 1-6, further comprising dividing a source video into a set of segments included in the first portion of video data, wherein determining that the film grain synthesis operation should be applied to the first portion of video data comprises determining that a denoising operation was performed successfully with each segment included in the set of segments and determining that a noise estimation operation was performed successfully with each segment included in the set of segments.
8. The computer-implemented method of any of clauses 1-7, further comprising dividing a source video into a set of segments included in the second portion of video data, wherein determining that the film grain synthesis operation should not be applied to the second portion of video data comprises determining that a denoising operation was not performed successfully with at least one segment included in the set of segments or determining that a noise estimation operation was not performed successfully with one or more segments included in the set of segments.
9. The computer-implemented method of any of clauses 1-8, wherein generating the encoded video data comprises accessing a denoised version of the first portion of video data based on a first pointer, accessing the second portion of video data based on a second pointer, and encoding the denoised version of the first portion of video data and the second portion of video data to generate the encoded video data.
10. The computer-implemented method of any of clauses 1-9, wherein generating the encoded video data comprises performing a denoising operation with the first portion of video data to generate a portion of denoised video data, performing a noise estimation operation with the first portion of video data to generate a noise model, generating a film grain table based on the noise model, wherein the noise model includes at least one film grain parameter, and generating at least one frame of encoded video data based on the portion of denoised video data and the film grain table.
11. Various embodiments include one or more non-transitory computer-readable media including instructions that, when executed by one or more processors, cause the one or more processors to selectively apply film grain synthesis when encoding and decoding media titles by performing the steps of determining that a film grain synthesis operation should be applied to a first portion of video data, determining that the film grain synthesis operation should not be applied to a second portion of video data, and generating encoded video data based on the first portion of video data and the second portion of video data, wherein the film grain synthesis operation is applied to the first portion of video data when decoding the encoded video data and the film grain synthesis operation is not applied to the second portion of video data when decoding the encoded video data.
12. The one or more non-transitory computer-readable media of clause 11, wherein the step of determining that the film grain synthesis operation should be applied to the first portion of video data comprises performing a denoising operation with the first portion of video data to generate a portion of denoised video data, performing a noise estimation operation with the first portion of video data to generate a noise model, and determining that the portion of denoised video data meets a first criterion, and determining that the noise model meets a second criterion.
13. The one or more non-transitory computer-readable media of any of clauses 11-12, wherein the step of determining that the film grain synthesis operation should not be applied to the second portion of video data comprises determining that a denoising operation or a noise estimation operation could not be performed with the second portion of video data.
14. The one or more non-transitory computer-readable media of any of clauses 11-13, wherein the step of determining that the film grain synthesis operation should not be applied to the second portion of video data comprises performing a denoising operation with the second portion of video data to generate a portion of denoised video data, performing a noise estimation operation with the second portion of video data to generate a noise model, and determining that the portion of denoised video data does not meet a first criterion, or determining that the noise model does not meet a second criterion.
15. The one or more non-transitory computer-readable media of any of clauses 11-14, wherein the first portion of video data corresponds to a first shot included in source video data, and the second portion of video data corresponds to a second shot included in the source video data.
16. The one or more non-transitory computer-readable media of any of clauses 11-15, wherein the first portion of video data corresponds to a first set of resolutions associated with a first shot included in source video data, and the second portion of video data corresponds to a second set of resolutions associated with a second shot included in the source video data.
17. The one or more non-transitory computer-readable media of any of clauses 11-16, further comprising dividing a source video into a set of segments included in the first portion of video data, wherein determining that the film grain synthesis operation should be applied to the first portion of video data comprises determining that a denoising operation was performed successfully with each segment included in the set of segments and determining that a noise estimation operation was performed successfully with each segment included in the set of segments.
18. The one or more non-transitory computer-readable media of any of clauses 11-17, further comprising the step of decoding the encoded video data by generating a first portion of decoded video data corresponding to the first portion of video data based on the encoded video data, extracting a film grain table from the first portion of decoded video data, and modifying the first portion of decoded video data to include film grain characteristics based on the film grain table.
19. The one or more non-transitory computer-readable media of any of clauses 11-18, wherein the film grain synthesis operation comprises adding film grain characteristics to a decoded portion of video data based on a model of film grain characteristics.
20. Various embodiments include a system comprising one or more memories storing instructions, and one or more processors coupled to the one or more memories that, when executing the instructions, perform the steps of determining that a film grain synthesis operation should be applied to a first portion of video data, determining that the film grain synthesis operation should not be applied to a second portion of video data, and generating encoded video data based on the first portion of video data and the second portion of video data, wherein the film grain synthesis operation is applied to the first portion of video data when decoding the encoded video data and the film grain synthesis operation is not applied to the second portion of video data when decoding the encoded video data.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for selectively applying film grain synthesis when encoding and decoding media titles, the method comprising:
determining that a film grain synthesis operation should be applied to a first portion of video data;
determining that the film grain synthesis operation should not be applied to a second portion of video data; and
generating encoded video data based on the first portion of video data and the second portion of video data,
wherein the film grain synthesis operation is applied to the first portion of video data when decoding the encoded video data and the film grain synthesis operation is not applied to the second portion of video data when decoding the encoded video data.

2. The computer-implemented method of claim 1, wherein determining that the film grain synthesis operation should be applied to the first portion of video data comprises:
performing a denoising operation with the first portion of video data to generate a portion of denoised video data;
performing a noise estimation operation with the first portion of video data to generate a noise model; and
determining that the portion of denoised video data meets a first criterion; and
determining that the noise model meets a second criterion.

3. The computer-implemented method of claim 1, wherein determining that the film grain synthesis operation should not be applied to the second portion of video data comprises determining that a denoising operation or a noise estimation operation could not be performed with the second portion of video data.

4. The computer-implemented method of claim 1, wherein determining that the film grain synthesis operation should not be applied to the second portion of video data comprises:
performing a denoising operation with the second portion of video data to generate a portion of denoised video data;
performing a noise estimation operation with the second portion of video data to generate a noise model; and
determining that the portion of denoised video data does not meet a first criterion, or determining that the noise model does not meet a second criterion.

5. The computer-implemented method of claim 1, wherein the first portion of video data corresponds to a first shot included in source video data, and the second portion of video data corresponds to a second shot included in the source video data.

6. The computer-implemented method of claim 1, wherein the first portion of video data corresponds to a first set of resolutions associated with a first shot included in source video data, and the second portion of video data corresponds to a second set of resolutions associated with a second shot included in the source video data.

7. The computer-implemented method of claim 1, further comprising dividing a source video into a set of segments included in the first portion of video data, wherein determining that the film grain synthesis operation should be applied to the first portion of video data comprises determining that a denoising operation was performed successfully with each segment included in the set of segments and determining that a noise estimation operation was performed successfully with each segment included in the set of segments.

8. The computer-implemented method of claim 1, further comprising dividing a source video into a set of segments included in the second portion of video data, wherein determining that the film grain synthesis operation should not be applied to the second portion of video data comprises determining that a denoising operation was not performed successfully with at least one segment included in the set of segments or determining that a noise estimation operation was not performed successfully with one or more segments included in the set of segments.

9. The computer-implemented method of claim 1, wherein generating the encoded video data comprises:
accessing a denoised version of the first portion of video data based on a first pointer;
accessing the second portion of video data based on a second pointer; and
encoding the denoised version of the first portion of video data and the second portion of video data to generate the encoded video data.

10. The computer-implemented method of claim 1, wherein generating the encoded video data comprises:
performing a denoising operation with the first portion of video data to generate a portion of denoised video data;
performing a noise estimation operation with the first portion of video data to generate a noise model;
generating a film grain table based on the noise model, wherein the noise model includes at least one film grain parameter; and
generating at least one frame of encoded video data based on the portion of denoised video data and the film grain table.

11. One or more non-transitory computer-readable media including instructions that, when executed by one or more processors, cause the one or more processors to selectively apply film grain synthesis when encoding and decoding media titles by performing the steps of:
determining that a film grain synthesis operation should be applied to a first portion of video data;
determining that the film grain synthesis operation should not be applied to a second portion of video data; and
generating encoded video data based on the first portion of video data and the second portion of video data,
wherein the film grain synthesis operation is applied to the first portion of video data when decoding the encoded video data and the film grain synthesis operation is not applied to the second portion of video data when decoding the encoded video data.

12. The one or more non-transitory computer-readable media of claim 11, wherein the step of determining that the film grain synthesis operation should be applied to the first portion of video data comprises:
performing a denoising operation with the first portion of video data to generate a portion of denoised video data;
performing a noise estimation operation with the first portion of video data to generate a noise model; and
determining that the portion of denoised video data meets a first criterion; and
determining that the noise model meets a second criterion.

13. The one or more non-transitory computer-readable media of claim 11, wherein the step of determining that the film grain synthesis operation should not be applied to the second portion of video data comprises determining that a denoising operation or a noise estimation operation could not be performed with the second portion of video data.

14. The one or more non-transitory computer-readable media of claim 11, wherein the step of determining that the film grain synthesis operation should not be applied to the second portion of video data comprises:
performing a denoising operation with the second portion of video data to generate a portion of denoised video data;
performing a noise estimation operation with the second portion of video data to generate a noise model; and
determining that the portion of denoised video data does not meet a first criterion, or determining that the noise model does not meet a second criterion.

15. The one or more non-transitory computer-readable media of claim 11, wherein the first portion of video data corresponds to a first shot included in source video data, and the second portion of video data corresponds to a second shot included in the source video data.

16. The one or more non-transitory computer-readable media of claim 11, wherein the first portion of video data corresponds to a first set of resolutions associated with a first shot included in source video data, and the second portion of video data corresponds to a second set of resolutions associated with a second shot included in the source video data.

17. The one or more non-transitory computer-readable media of claim 11, further comprising dividing a source video into a set of segments included in the first portion of video data, wherein determining that the film grain synthesis operation should be applied to the first portion of video data comprises determining that a denoising operation was performed successfully with each segment included in the set of segments and determining that a noise estimation operation was performed successfully with each segment included in the set of segments.

18. The one or more non-transitory computer-readable media of claim 11, further comprising the step of decoding the encoded video data by:
generating a first portion of decoded video data corresponding to the first portion of video data based on the encoded video data;
extracting a film grain table from the first portion of decoded video data; and
modifying the first portion of decoded video data to include film grain characteristics based on the film grain table.

19. The one or more non-transitory computer-readable media of claim 11, wherein the film grain synthesis operation comprises adding film grain characteristics to a decoded portion of video data based on a model of film grain characteristics.

20. A system comprising:
one or more memories storing instructions; and
one or more processors coupled to the one or more memories that, when executing the instructions, perform the steps of:
determining that a film grain synthesis operation should be applied to a first portion of video data,
determining that the film grain synthesis operation should not be applied to a second portion of video data, and
generating encoded video data based on the first portion of video data and the second portion of video data,
wherein the film grain synthesis operation is applied to the first portion of video data when decoding the encoded video data and the film grain synthesis operation is not applied to the second portion of video data when decoding the encoded video data.
